(19) United States
(12) Patent Application Publication
(10) Pub. No.: US 2024/0089945 A1
(43) Pub. Date: Mar. 14, 2024

(54) PARTIAL RELEASE OF SPS RESOURCES

(71) Applicant: Telefonaktiebolaget LM Ericsson (publ), Stockholm (SE)

(72) Inventors: Bikramjit SINGH, Raasepori (FI); Majid GERAMI, Lund (SE)

(21) Appl. No.: 18/274,241

(22) PCT Filed: Jan. 28, 2021
(86) PCT No.: PCT/SE2021/050059

§ 371 Date: Jul. 26, 2023

(51) Int. Cl. H04W 72/11; H04L 1/1829

(52) U.S. Cl. CPC H04W 72/11; H04L 1/1864

(57) ABSTRACT

Embodiments of the present disclosure provide a method, a network node, and a computer program product for handling release of semi-persistent scheduling, SPS, resources configured for one or more user equipments, UEs, in a wireless communication network. The method is performed in a network node in the wireless communication network. The method includes generating information indicating the release of the one or more SPS resources. The one or more SPS resources are a subset of SPS resources associated with a single SPS identifier, ID, or multiple SPS IDs configured for the one or more UEs. Further, the method includes transmitting the DCI message to the one or more UEs for causing the one or more UEs to release the one or more SPS resources.

### TECHNICAL FIELD

The present disclosure relates to the field of wireless communication. More particularly, to method, network node and computer program products for handling release of Semi-Persistent Scheduling, SPS, resources for User Equipments, UEs, in a wireless communication network.

### BACKGROUND

Semi-Persistent Scheduling, SPS, is a feature defined by the Third Generation Partnership Project, 3GPP, that significantly reduces control channel overhead for Quality of Service, QoS, applications or services such as Voiceover Long Term Evolution, VoLTE, that require periodical radio resource allocations.

Procedures of SPS and Downlink Control Information, DCI, formats are defined in 3GPP Technical Specification, TS, 38.213, Release 8, in which both SPS resource activation and release methods are specified.

New Radio, NR, standard in 3GPP is designed to provide service for multiple use cases such as enhanced mobile broadband, eMBB, ultra-reliable and low latency communication, URLLC, and machine type communication, MTC. Each of these services has different technical requirements. For example, the general requirement for eMBB is high data rate with moderate latency and moderate coverage, while URLLC service requires a low latency and high reliability transmission.

In NR, semi-persistently pre-configured transmission is supported, for Uplink, UL, that is defined as Configured Grant, CG, and for Downlink, DL, it is defined as DL SPS.

In existing NR Rel-16 standard, each SPS resource configuration has a unique configuration ID which is also termed as SPS ID. The SPS ID is set in Radio Resource Control, RRC, table. Thus, the number of configurations for UL CG or DL-SPS equals to number of configuration IDs in RRC table. A single configuration with one configuration ID cannot be interpreted as multiple configurations.

In the NR Rel-16 standard, the SPS activation and release procedure is as described herein. A DL-SPS configuration or an UL-CG Type 2 configuration is activated or released by a Downlink Control Information, DCI message. For each configuration to be activated one single DCI is needed. Thus, the number of active configurations for DL-SPS and Type 2 UL-CG equals to the number of activation DCI messages before receiving deactivation DCI for those configurations. A release DCI message is transmitted for releasing a single configuration or a group of configurations. When a configuration is released, all the resource allocation for that configuration ID is released. Further, a group of configurations can also be released by a single DCI message. When a configuration or a group of configurations is released, all the assigned resources for those configurations are released.

Consequently, there is a need for an improved method and arrangement for release of SPS resources that alleviates at least some of the above cited problems.

### SUMMARY

It is therefore an object of the present disclosure to provide a method, a network node and a computer program product for partial release of SPS resources that seeks to mitigate, alleviate, or eliminate all or at least some of the above-discussed drawbacks of presently known solutions.

This and other objects are achieved by means of a method, a computer program product, and a device as defined in the appended claims. The term exemplary is in the present context to be understood as serving as an instance, example or illustration.

According to a first aspect of the present disclosure, a method for handling release of semi-persistent scheduling, SPS, resources configured for one or more user equipments, UEs in a wireless communication network is provided. The method is performed by a network node, for example, a base station in the wireless communication network. The method comprises generating information indicating the release of the one or more SPS resources. The one or more SPS resources are a subset of SPS resources associated with a single SPS identifier, ID or multiple SPS IDs configured for the one or more UEs. Further, the method comprises transmitting the generated information to the one or more UEs for causing the one or more UEs to release the one or more SPS resources.

In some embodiments, the method further comprising determining that the one or more SPS resources within a set of SPS resources configured for the one or more UEs is to be released.

In some embodiments, determining that the one or more SPS resources within the set of SPS resources configured for the one or more UEs is to be released comprises determining whether the one or more UEs is configured with a single SPS ID, or multiple SPS IDs. If the one or more UEs is configured with the single SPS ID, determining one or more SPS resources associated with the single SPS ID. If the one or more UEs is configured with multiple SPS IDs, determining one or more SPS resources associated with multiple SPS IDs

In some embodiments, the generated information indicating the release of the one or more SPS resources comprises one or more of: a SPS ID, multiple SPS IDs, a start time interval to an end time interval associated with the one or more SPS resources, indication of information including a slot number, a start slot number to an end slot number associated with the one or more SPS resources, a physical resource block number, PRB, a start of PRB to an end of PRB, SPS periodicity, number of repetitions associated with SPS periodicity, number of repetitions in each of the SPS resources, periodic SPS resources in each slot, repetition IDs, a bitmap of one or more SPS resource numbers, and a priority indicator indicating release of one or more SPS resources for a pre-determined time interval.

In some embodiments, the number of repetitions of the periodic SPS resources defining a period over which the SPS resources reoccur, wherein the number of repetitions for each period are associated with one or more of a start time interval and an end time interval, a start slot number and an end slot number, a start of a periodic resource to an end of a periodic resource, wherein the number of the repetitions are associated with the single SPS ID or multiple SPS IDs.

In some embodiments, the generated information is transmitted to the one or more UEs (102a-102n) in one or more of: a Downlink Control Information, DCI, message and a Medium Access Control, MAC, Control Element, MAC-CE.

In some embodiments, the generated information is transmitted to each UE based on a UE capability information received from each UE, for causing each UE to release the one or more SPS resources, wherein the UE capability information being indicative of one or more of: releasing capability for release of the one or more SPS resources, processing capability for processing the received information, memory capacity for storing the received information.

In some embodiments, the generated information is transmitted to a plurality of UEs in a group for causing the plurality of UEs to release the one or more SPS resources, wherein the plurality of UEs in a group is identified using a group ID.

In some embodiments, a DCI message is transmitted to each UE to release the one or more SPS resources or a group-common DCI message is transmitted to the plurality of UEs to release the one or more SPS resources.

In some embodiments, the one or more SPS resources within the set of SPS resources represent downlink, DL, SPS resources or uplink, UL, SPS resources configured for the one or more UEs.

In some embodiments, the one or more SPS resources represent time-frequency resources supporting one or more resource configurations, wherein the one or more resource configurations is one of a slot-based, a sub-slot based, a mini-slot based or a time symbol based resource configuration.

In some embodiments, the method further comprises receiving an acknowledgement, ACK, message or a negative acknowledgement, a NACK, message, related to the release of the one or more SPS resources from each of the one or more UEs. If the NACK is received from each of the one or more UEs, the method comprises retransmitting the generated information for causing the one or more UEs to release the one or more SPS resources.

In some embodiments, the ACK message is received through one of hybrid automatic repeat request, HARQ, ACK, HARQ-ACK, codebook Type-1, HARQ-ACK, codebook Type-2, and enhanced HARQ-ACK, codebook Type-2 and HARQ-ACK, codebook Type-3 over a physical uplink control channel, PUCCH or a physical uplink shared channel, PUSCH.

In some embodiments, the ACK message is received through medium access control, MAC, control elements, MAC CEs over PUSCH, wherein the MAC CEs comprises a bit field indicating a release of the one or more SPS resources or a complete release of the SPS resources.

In some embodiments, the method further comprises transmitting new information to the one or more UEs for re-assigning the one or more SPS resources released by the one or more UEs.

According to a second aspect of the present disclosure, a method for releasing semi-persistent scheduling, SPS, resources configured for a user equipment, UE, in a wireless communication network is provided. The method is performed by the UE in the wireless communication network. The method comprises receiving from a network node, information indicating the release of one or more SPS resources within a set of SPS resources configured for the UE, wherein the one or more SPS resources are a subset of SPS resources associated with a single SPS identifier, ID, or multiple SPS IDs. The method comprises releasing the one or more SPS resources indicated in the received information.

In some embodiments, the method further comprises transmitting to the network node, an acknowledgement, ACK, message or a negative acknowledgement, NACK, message, related to the release of the one or more SPS resources. If the NACK is transmitted to the network node, the method comprises receiving, from the network node, information indicating one or more SPS resources for releasing the one or more SPS resources.

In some embodiments, the information indicating the release of the one or more SPS resources is received in one or more of: a Downlink Control Information, DCI, message and a Medium Access Control, MAC, Control Element, MAC-CE.

In some embodiments, the ACK message is transmitted through one of a hybrid automatic repeat request, HARQ, ACK, HARQ-ACK, codebook Type-1, a HARQ-ACK, codebook 2, and an enhanced HARQ-ACK, codebook Type-2, and HARQ-ACK, codebook Type-3 over a physical uplink control channel, PUCCH or a physical uplink shared channel, PUSCH.

In some embodiments, the ACK message is transmitted through medium access control, MAC, control elements, MAC CEs over PUSCH, wherein the MAC CEs comprises a bit field indicating a release of one or more SPS resources or a complete release of SPS resources.

In some embodiments, the method further comprises receiving, from the network node, a new DCI message comprising one or more SPS resources re-assigned by the network node after releasing the one or more SPS resources.

According to a third aspect of the present disclosure, a base station for handling release of release of semi-persistent scheduling, SPS, resources configured for one or more user equipments, UEs, in a wireless communication network is provided. The base station being adapted for generating information indicating the release of the one or more SPS resources. The one or more SPS resources are a subset of SPS resources associated with a single SPS identifier, ID or multiple SPS IDs configured for the one or more UEs. Further, the base station being adapted for transmitting the generated information to the one or more UEs for causing the one or more UEs to release the one or more SPS resources.

According to a fourth aspect of the present disclosure, there is provided a UE, for releasing semi-persistent scheduling, SPS, resources configured for the UE, in a wireless communication network is provided. The UE being adapted for receiving, from a network node, information indicating the release of one or more SPS resources within a set of SPS resources configured for the UE, wherein the one or more SPS resources are a subset of SPS resources associated with a single SPS identifier, ID, or multiple SPS IDs. Further, the UE being adapted for releasing the one or more SPS resources indicated in the received information.

According to a fifth aspect of the present disclosure, there is provided a computer program product comprising a non-transitory computer readable medium, having thereon a computer program comprising program instructions. The computer program is loadable into a data processing unit and configured to cause execution of the method according to any of the first and second aspects when the computer program is run by the data processing unit.

An advantage of some embodiments is that alternative and/or improved approaches for handling release of one or more SPS resources configured for the UE(s).

An advantage of some embodiments is that the proposed method allows release of UL or DL SPS resources in a flexible manner. For example, the proposed method can be used for release of SPS resource(s) associated with a single SPS ID or multiple SPS IDs.

An advantage of some embodiments is that, with the release DL SPS resources or UL SPS resources in a flexible manner, the PDCCH resources can be saved for deactivating and then activating the DL SPS resources or UL SPS resources again.

Additionally, the proposed method can be used to transmit generated information, for example, a single DCI message can be transmitted over PDCCH or PDSCH from the network node to UE to release a sub-set of resources within a single DL SPS, a single UL SPS or Configured Grants, CGs, multiple DL SPSs and multiple UL SPSs or CGs.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIGS. 1A and 1B disclose an example wireless communication network according to some embodiments;

FIGS. 2A and 2B is an example schematic diagram showing periodic SPS resources configured for UE(s) according to some embodiments;

FIG. 3 is a flowchart illustrating example method steps for handling release of SPS resources configured for UE(s) according to some embodiments;

FIG. 4 is an example schematic diagram for release of a subset of resources in a single SPS configuration according to some embodiments;

FIG. 5 is a flowchart illustrating example method steps for releasing SPS resources configured for UE according to some embodiments;

FIG. 6 is an example schematic diagram showing functional modules of a network node according to some embodiments;

FIG. 7 is an example schematic diagram showing functional modules of a UE according to some embodiments; and

FIG. 8 discloses an example computing environment according to some embodiments.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Embodiments of the present disclosure will be described and exemplified more fully hereinafter with reference to the accompanying drawings. The solutions disclosed herein can, however, be realized in many different forms and should not be construed as being limited to the embodiments set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

In the present disclosure, user equipments, UEs, also known as mobile terminals, and/or wireless terminals are enabled to communicate wirelessly with a network node in a wireless communication network.

Typically, a network node may serve or cover one or several cells of the wireless communication network. That is, the network node provides radio coverage in the cell(s) and communicates over an air interface with the UE(s) operating on radio frequencies within its range. The network node may be also referred to as “eNB”, “eNodeB”, “NodeB” or “gNB”, depending on the technology and terminology used. In the present disclosure, the network node device may also be referred to as a base station, BS.

In the present disclosure, it is assumed that connection establishment has already been completed between the UE(s) and the network node.

In the following description of exemplary embodiments, the same reference numerals denote the same or similar components.

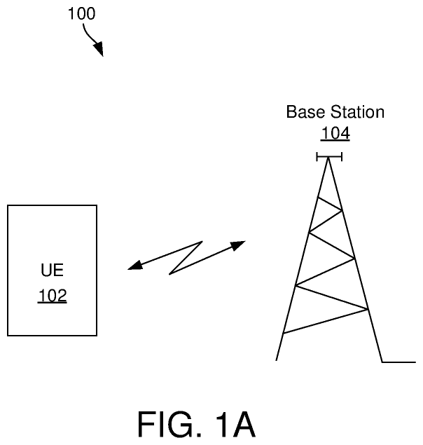

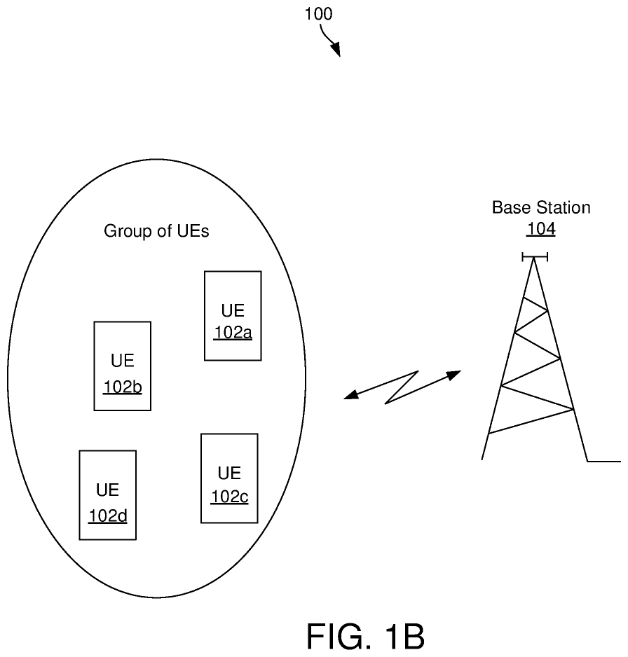

FIGS. 1A and 1B disclose an example wireless communication network 100 for handling release of semi-persistent scheduling, SPS, resource(s) configured for User Equipment(s). As depicted in FIG. 1A, the wireless communication network 100 includes a user equipment, UE 102 and a base station 104.

The base station 104 can be for example a new radio, NR, base station i.e., a gNB or an evolved node base station i.e., eNB, or the like. The UE 102 communicates with the base station 104 serving the UE 102. The communication from the base station 104 to the UE 102 is referred to as downlink, DL, communication, whereas communication from the UE to the base station is referred to as uplink, UL, communication. Thus, the UE 102 involves in bidirectional radio communication with the base station 104.

There can be a plurality of UEs 102a-102n in the coverage of the base station 104 as depicted in FIG. 1B. The plurality of UEs 102a-102n may belong to a group and the UEs 102a-102n in the group may be identified using a group ID.

In the case the UE 102 has data to be transmitted to the base station 104, the UE 102 requires an allocation of a radio resource in order to be able transmit the data to the base station 104.

For this reason, the UE 102 can request radio resources in a radio resource request directed to the base station 102, for instance in a radio resource request message. The base station may then determine a semi-persistent scheduling of radio resources, based on the received radio resource request. Having determined that radio resources shall be allocated by using a semi-persistent scheduling, the base station 104 can then transmit a UL semi-persistent scheduling grant for the UL radio resource. This semi-persistent scheduling grant typically comprises a set of physical layer parameters that can activate the UL semi-persistent scheduling for the UE.

The UL SPS resources i.e., UL SPS configured grant may be communicated to the UE on the Physical Downlink Control Channel, PDCCH. In addition, the base station 104 also transmits DL semi-persistent scheduling resources, i.e., DL SPS resources so as to inform the UE of a time/frequency domain in which the DL data is supposed to be transmitted, coding, a data size, and hybrid automatic repeat and request, HARQ, related information or the like.

After scheduling or configuring the SPS resources i.e., either UL SPS resources or DL SPS resources for the UEs 102a-102n, there may be a situation, where the base station 104 may intend to release certain part of the SPS resources which may happen, e.g., over a certain period of time, where the base station expects a change in traffic pattern, change in channel conditions and emergence of high priority traffic. The base station implements a method for handling release of one or more SPS resources configured for the UEs 102a-102n as described herein.

According to some embodiments of the present disclosure, the base station 102 determines that one or more SPS resources i.e., either UL SPS resources or DL SPS resources within a set of SPS resources configured for the one or more UEs 102a-102n to be released. For example, the one or more SPS resources are a subset of SPS resources associated with a single SPS identifier, ID, or multiple SPS IDs configured for the one or more UEs 102a-102n. The base station 104 generates information indicating the release of the one or more SPS resources configured for the UEs.

The generated information indicating the release of the one or more SPS resources comprises a SPS ID, multiple SPS IDs, a start time interval to an end time interval associated with the one or more SPS resources, indication of information including a slot number, a start slot number to an end slot number associated with the one or more SPS resources, a physical resource block number, PRB, a start of PRB to an end of PRB, SPS periodicity, number of repetitions associated with SPS periodicity, number of repetitions in each of the SPS resources, periodic SPS resources in each slot, repetition IDs, a bitmap indicating one or more resource numbers and a priority indicator indicating release of one or more SPS resources for a pre-determined time interval.

Further, the base station 104 transmits the generated information to the UEs 102a-102n for causing the release of one or more SPS resources. The generated information may be transmitted to the one or more UEs 102a-102n in a Downlink Control Information, DCI, message or a Medium Access Control, MAC, Control Element, MAC-CE, or the like.

The generated information may be transmitted to each UE 102a-102n for causing the release of one or more SPS resources. For example, each DCI message may be transmitted to each UE 102a-102n for causing the release of one or more SPS resources or a group-common DCI message may be transmitted to the plurality of the UEs 102a-102n in the group (as shown FIG. 1B) for causing the release of one or more SPS resources.

In some examples, the transmitted information (i.e., for example in a DCI message) includes information indicating a release of a part of SPS resources from a single SPS ID #X, e.g., from time Tᵢ to time Tⱼ, or slot Sᵢ to slot Sⱼ, or periodic resource Rᵢ to periodic resource Rⱼ, or a subset of frequency resources of the SPS ID #X.

In another example, if Sᵢ and Sⱼ are not indicated in the DCI message, then whole SPS resource in the SPS ID #X may be released by the UEs 102a-102n. If only Sᵢ is indicated, then SPS would be released from slot Sᵢ till end. If only Sⱼ is indicated, then SPS would be released from immediate resource till slot Sⱼ.

In some examples, the transmitted information includes bitmap of one or more SPS resource numbers such 1, 5 and 10. In another example, the one or more SPS resource numbers may be 10, 20 and 30. Therefore, it should be noted that the bitmap of one or more SPS resource numbers may include a defined sequence of numbers of the SPS resources or a randomly selected SPS resource numbers.

In some examples, DCI message includes specific time-frequency resource allocations, for example, from slot Sᵢ to slot Sⱼ and from PRB m to PRB n for causing the release of SPS resource(s).

Thus, the base station 104 indicates relevant information (in the DCI message) e.g., SPS ID #X, time window information, e.g., Ti and/or Tj, Sᵢ and/or Sⱼ for causing the release of SPS resource(s). Various information which can be included in the DCI message for handling release of the SPS resource(s) is explained in the later parts of the disclosure.

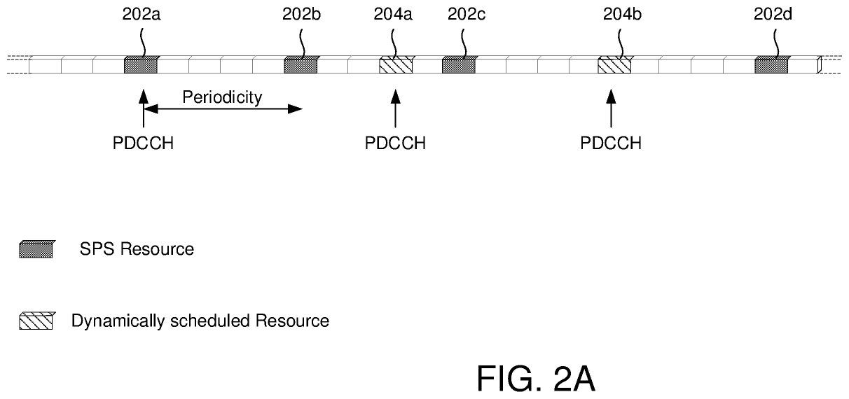

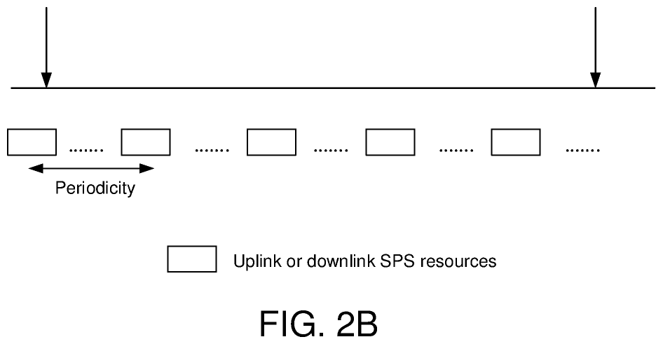

FIGS. 2A and 2B is an example schematic diagram showing periodic SPS resources configured for the UE(s). With semi-persistent scheduling, the UE(s) are provided with the scheduling decision on the PDCCH, together with an indication that this applies to every nth sub-frame until further notice by the base station 104. Hence, control signaling is only used once and the control channel overhead is reduced, as illustrated in FIG. 2A. The periodicity of semi-persistently scheduled transmissions (that is, the value of n) configured by RRC signaling in advance, while activation and deactivation are done using the PDCCH. For example, for voice-over IP, the scheduler can configure a periodicity of 20 ms for semi-persistent scheduling and, once a talk spurt starts, the semi-persistent scheduling pattern is triggered by the PDCCH.

After enabling semi-persistent scheduling, the UE continues to monitor the PDCCH for uplink and downlink scheduling commands. When a dynamic scheduling command is detected, it takes precedence over the semi-persistent scheduling in that particular sub-frame, which is useful if the semi-persistently allocated resources occasionally need to be increased. For example, for voice-over IP in parallel with web browsing it may be useful to override the semi-persistent resource allocation with a larger transport block when downloading the web page.

For the downlink, only initial transmissions use semi-persistent scheduling. Retransmissions are explicitly scheduled using a PDCCH assignment. This follows directly from the use of an asynchronous hybrid-ARQ protocol in the downlink. Uplink retransmissions, in contrast, can either follow the semi-persistently allocated sub-frames or be dynamically scheduled.

According to existing standard, the gNB provides an SPS resource configuration via RRC signaling to the UE, and the UE configures SPS resources based on the SPS resource configuration.

Thus, the UE may be allocated in downlink and/or uplink periodic radio resources without the need for transmission of additional grants by the base station. The periodic resource allocation may remain activated until it is released. The periodic resource allocation for example, may be called, SPS or grant-free scheduling, or periodic multi-subframe scheduling, and/or the like. In this disclosure, the example term SPS is mostly used, but other terms may also be equally used to refer to periodic resource allocation, e.g. grant-free scheduling. An example periodic resource allocation i.e., activation and release is shown in FIG. 2B.

In some embodiments of the present disclosure, the base station transmits the information indicating the release of periodic SPS resources. For example, the transmitted information in the DCI message comprises SPS periodicity which includes number of repetitions of periodic SPS resources defining a period over which the SPS resources reoccur.

Each periodic SPS resource i.e., either UL SPS resource or DL SPS resource may include K repetitions. The base station transmits the DCI message to the UE(s) comprising information indicating the release of resource for, e.g. repetitions {xi, . . . , xj} per period from time T1 to time T2 or slot S1 to slot S2, or periodic resource Ri to periodic resource Rⱼ of SPS.

In another example, base station transmits the DCI message to the UE(s) to release resource for repetitions {a, m, r} per period from time T1 to time T2 or slot S1 to slot S2, or periodic resource Rᵢ to periodic resource Rⱼ associated with SPS ID.

In yet another example, the base station transmits the DCI message to the UE(s) comprising information which include repetition indices {a, m and r} with in the SPS periodicity.

In some embodiments in case of dynamic allocation for UL and DL resources, the base station indicates relevant information in the DCI message. For example, if the UE(s) are configured with a single SPS ID, the DCI message includes the SPS ID, a subset or window of resources to be released by the UE, e.g., Slot G to Slot G+N, repetition IDs, e.g., if a UE is allocated with 4 repetitions in each slot, then in order to release repetition resource corresponding to repetition 3 and 4, the DCI message indicates the repetition ID 3 and 4.

Thus, in this example, the base station transmits the DCI message with information indicating the SPS ID, slot number G to G+N, and repetition ID 3 and 4.

In some examples, if the UE(s) are configured with SPS periodicity N and when there are 4 repetitions within a period, then the DCI message may include information indicating release of last two repetitions at a periodicity 2N, which indicates that consecutive periods have 2 and 4 repetitions.

When the UE(s) are configured with multiple SPS IDs, then the DCI message comprises multiple SPS IDs or a group ID that maps to multiple SPS IDs. The DCI message may further include information related to release of the resources e.g., Slot G to Slot G+N, repetition IDs, e.g., if a UE is allocated with 4 repetitions in each slot, then in order to release repetition resource corresponding to repetition 3 and 4, the DCI message indicates the repetition ID 3 and 4.

Further, in case of dynamic allocation, transmitted information in the DCI message may include HARQ ID or resource allocation corresponding to the dynamic allocation. Further, the DCI message may include the repetition IDs that are to be released in the dynamic allocation.

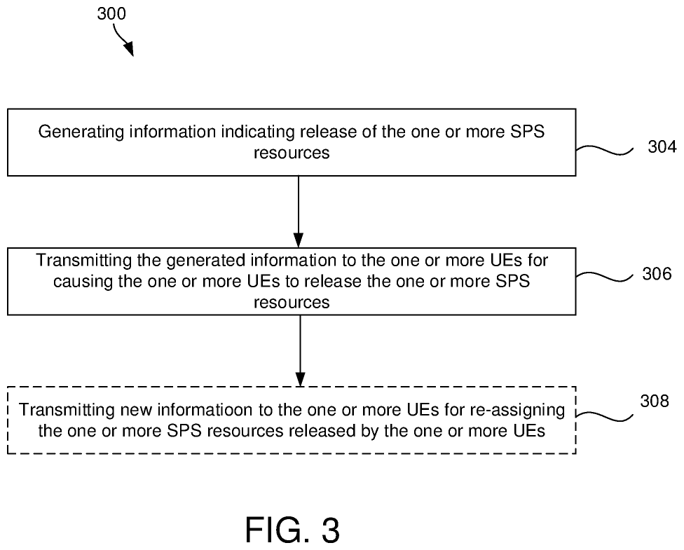

FIG. 3 is a flowchart illustrating an example method 300 for handling release of SPS resources configured for UE(s). As stated above, the base station performs method 300 for handling release of SPS resources configured for UE(s) in the wireless communication network. The SPS resources represent time-frequency resources supporting resource configurations which can be a slot-based, a sub-slot based, a mini-slot based or a time symbol based resource configuration. It should be noted that the one or more SPS resources are a subset of SPS resources associated with the single SPS ID or multiple SPS IDs.

At step 304, the method 300 comprises generating information indicating release of the one or more SPS resources. For example, a DCI message may be generated with the one or more SPS resources associated with single SPS ID or multiple SPS IDs for indicating the release of the one or more SPS resources.

In an embodiment, the one or more SPS resources within a set of SPS resources configured for the UE(s) are determined for generating the information indicating the release of one or more SPS resources. For example, determining the one or more SPS resources configured for the UE(s) comprises determining whether the UE(s) are configured with a single SPS ID or multiple SPS IDs. If the UE(s) are configured with single SPS ID, then the one or more SPS resources associated with single SPS ID are determined. For example, the one or more SPS resources are a subset of SPS resources associated with the single SPS ID. If the UE(s) are configured with multiple SPS IDs, then one or more SPS resources which are a subset of SPS resources associated with multiple SPS IDs are determined.

In some examples, an existing DCI message or format can be used for indicating the release of the SPS resources either partially or completely by interpreting the fields of DCI format.

The base station may indicate the UE about partial release through DCI format 0-0 and 0-1 for UL SPS resources, and DCI format 1-0 and 1-1 for the DL SPS. There are some bits in these DCI formats e.g. modulation and coding scheme, MCS, time-domain resource allocation, TDRA, and power control i.e., TPC command that are not used in the message. These bits in the message DCI message may be used for indicating the release of SPS resources. Further, the base station may indicate the UE about partial release of SPS resources through new DCI format. The new DCI format can be a group-common DCI format or UE specific DCI format.

The generated information may include various parameters indicating the SPS resource(s) to be released. For example, the information in the DCI message may include but not limited to a SPS ID, multiple SPS IDs, a start time interval to an end time interval associated with the one or more SPS resources, indication of information including a slot number, a start slot number to an end slot number associated with the one or more SPS resources, a PRB, a start of PRB to an end of PRB, SPS periodicity, number of repetitions associated with SPS periodicity, number of repetitions in each of the SPS resources, periodic SPS resources in each slot, repetition IDs, a bitmap indicating one or more resource numbers and a priority indicator indicating release of one or more SPS resources for a pre-determined time interval.

At step 306, the method 300 comprises transmitting the generated information to the UE(s) for causing the UE(s) to release the one or more SPS resources. For example, the base station transmits generated information to each UE based on UE capability information received from each of the UEs. The UE capability information may be specific to each UE which may include but not limited to, releasing capability for release of SPS resource(s), processing capability for processing the received information, memory capacity for storing the received information or the like.

In another example, the base station transmits a group-common DCI message to a plurality of UEs in a group for causing the plurality of UEs to release the SPS resource(s) indicated in the group-common DCI message. The group-common DCI message may be transmitted to the plurality of UEs in the group using a group ID which is assigned for the plurality of UEs in the group that have low priority traffic, part of their traffic or configurations having low priority traffic or non-critical data.

In response to the DCI message comprising the information indicating the release of SPS resource(s) to the UE(s), the base station receives an acknowledgement, ACK, message or a negative acknowledgement, a NACK, message, related to the release of the SPS resource(s) from each of the UE(s). For example, the base station may receive the ACK message from the UE(s) through one of hybrid automatic repeat request, HARQ, ACK, HARQ-ACK, codebook Type-1, HARQ-ACK, codebook Type-2, enhanced HARQ-ACK, codebook Type-2 and HARQ-ACK, codebook Type-3 over a physical uplink control channel, PUCCH or a physical uplink shared channel, PUSCH.

In an embodiment, the base station may receive the ACK message is received through medium access control, MAC, control elements, MAC CEs over PUSCH. The MAC CEs may include a bit field indicating a partial release of the SPS resource(s) or a complete release of the SPS resource(s) indicated in the message. The bit field may be enabled with a binary value, for example, ‘0’ to indicate the partial release of the SPS resource(s) and ‘1’ to indicate the complete release of the SPS resources(s).

Optionally, if the NACK is received from any of the UE(s), then the base station may retransmit the information comprising the information indicating the SPS resource(s) to be released by the UE(s).

Optionally, at step 308, the method comprises transmitting a new information, for example, a new DCI message to the UE(s) for re-assigning the SPS resource(s) released by the UEs. If the SPS resource(s) Resource #R associated with SPS ID #X is released partially, the base station may transmit a new DCI message, for re-assigning SPS resources to the SPS ID #X. For example, with the new DCI message, the base station may re-assign the released resources Resource #R to the existing SPS ID #X.

In some examples, if the SPS resource(s) associated with SPS ID #X is released partially, i.e., a SPS Resource #R is released from the set of SPS Resources #U, i.e., the SPS Resource #R being a subset of the set of Resources #U, then the base station may re-assign the Resource #R in the form of dynamic HARQ process.

In another example, the base station may re-assign the released resource Resource #R as a part of another SPS, i.e., SPS ID #Y. In another example, the base station may deactivate the SPS ID #X and reactivate the ID #X now by including the previously released resources i.e., Resource #R.

The base station may transmit the new information, for example, a new DCI message for reassigning the SPS resource(s) based on a change in traffic pattern for the UEs, change in channel conditions and emergence of high priority traffic or the like.

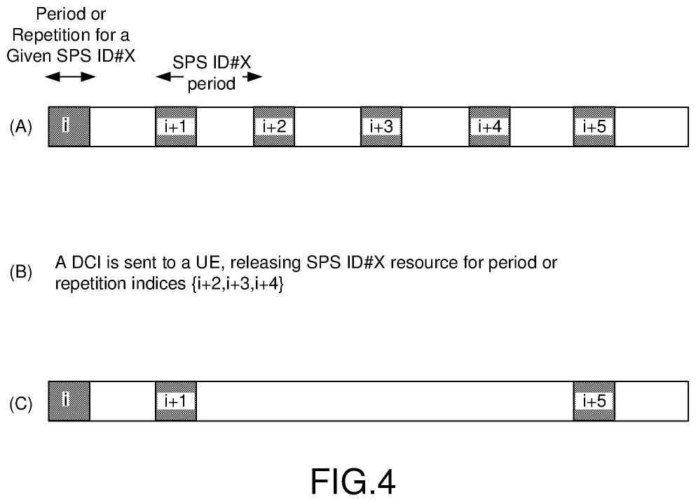

FIG. 4 is an example schematic diagram for release of a subset of resources in a single SPS configuration. As depicted in FIG. 4, the UE is configured with a single SPS resource configuration. The single SPS configuration is identified with a SPS ID #X. The SPS ID #X includes periodic SPS resources starting from i to i+5. The base station transmits the information indicating the SPS resources with repetition indices {i+2, i+3 and i+4} to be released. The UE receives the information from the base station and releases the SPS resources {i+2, i+3 and i+4} indicated in the DCI message. Thus, one or more SPS resources associated with single SPS ID can be released by the UE in response to the DCI message from the base station.

Although not shown in FIG. 4, one or more SPS resources associated with multiple SPS IDs may be released by the UE in response to the DCI message from the base station. For example, the base station may transmit the information, (for example in a DCI message) indicating the SPS resources with repetition index {i+2} in SPS ID #1, repetition index {i+5} in SPS ID #3 and repetition index {i+4} in SPS ID #5 to be released. The UE receives the DCI message comprising the information indicating SPS resources associated with multiple SPS IDs and releases the indicated SPS resources with repetition index {i+2} in SPS ID #1, repetition index {i+5} in SPS ID #3 and repetition index {i+4} in SPS ID #5.

In case, when the UE(s) are configured with three SPS configurations namely {SPS ID #1, SPS ID #2, SPS ID #3}. The DCI release message may indicate the information for release of the SPS resource(s) as described herein.

For example, the DCI message may include the information indicating the SPS resources i.e., SPS ID #1 with repetition indices {i, i+1, i+2} and SPS ID #2 with repetition indices {j+6, j+7, j+8, j+9} to be released by the UE.

In another example, the DCI message include the information indicating all the SPS resources between Slot N and Slot N+X to be released only for SPS ID #1 and SPS ID #3 and no SPS resources to be released for SPS ID #2.

In some examples, the DCI message include the information indicating all the SPS resources until time ‘T’ only for SPS ID #2 to be released and no SPS resources to be released for SPS ID #1 and SPS ID #3.

In some examples, the DCI message include the information indicating all the SPS resources between Slot N and Slot N+X to be released for SPS I D #1, SPS ID #2 and SPS ID #3.

In some examples, the DCI message include the information indicating repetitions of SPS resources i.e., last two repetitions to be released for SPS ID #1 and only last four repetitions of SPS ID #2 and SPS ID #3 between time ‘T1’ and time ‘T2’ to be released.

Further, in some examples, the repetitions of SPS resources can be removed partially by including the repetitions in the DCI message. If each SPS resource consists of multiple repetition occasions, e.g., occasion i constituted of four repetitions occasions, i.e., i_1, i_2, i_3 and i_4, and four repetitions are scheduled per resource occasion, then the base station transmits the DCI message comprising the information indicating the release of repetitions partially. The DCI message includes specific repetitions from all the resource occasions. As shown in FIG. 4, for example, repetition 2 and repetition 4 from all the resource occasions starting from occasion ‘i’ to the last possible resource occasion in SPS, ‘i+5’.

In another example, the DCI message includes indication of repetitions partially from specific resource occasions. As shown in FIG. 4, repetition 2 and repetition 4 may be released only in resource occasions i+2, i+3 and i+4.

Although in the above examples DCI message is used for transmitting the information indicating the release of one or more SPS resources, it should be noted that MAC Control Elements, MAC-CEs may be used for transmitting the information indicating the release of one or more SPS resources.

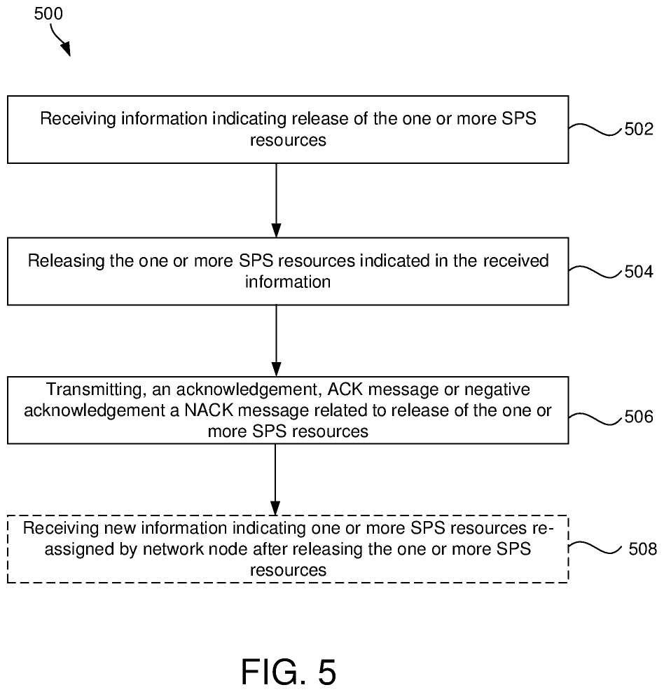

FIG. 5 is a flowchart illustrating example method steps for releasing SPS resources configured for UE. The UE performs method 500 for releasing SPS resource(s) indicated in the DCI message by the base station. At step 502, the 500 comprises receiving information indicating release of SPS resource(s) which are subset of SPS resources associated with a single SPS ID or multiple SPS IDs.

For example, the information may be received in a DCI message or in a MAC CE. The information received in the DCI message may include but not limited to a SPS ID, multiple SPS IDs, a start time interval to an end time interval associated with the one or more SPS resources, a slot number, a start slot number to an end slot number associated with the one or more SPS resources, a physical resource block number, PRB, a start of PRB to an end of PRB, SPS periodicity, number of repetitions associated with SPS periodicity, number of repetitions in each of the SPS resources, periodic SPS resources in each slot, repetition IDs, a bitmap indicating one or more resource numbers, and a priority indicator indicating release of one or more SPS resources for a pre-determined time interval.

At step 504, the method comprises releasing the SPS resource(s) indicated in the received information. The UE releases the SPS resource(s) associated with a single SPS ID or the SPS resource(s) associated with multiple SPS IDs as indicated in the DCI message. The UE releases the SPS resource(s) associated with pre-determined beams or antenna ports being used by the UE.

For example, when the UE releases the resource occasions for DL data e.g., i+2, i+3, i+4 occasions as shown in FIG. 4, then the UE shall not send any acknowledgement message for the corresponding DL transmissions as there exists no resources for the UE due to release of those resources.

For acknowledgement in UL direction, if the UE receives the information (i.e., in a DCI message or in a MAC CE) for sub-set of SPS resources, then UL feedback codebook of any type—type-1, type-2, enhanced type-2, type-3 codebook shall be updated, e.g., by not allocating bits/acknowledgment for the released resources, as the UE shall not to send any acknowledgement related to the released resources, and therefore the no resources shall be allocated in the codebook for the feedback of released resources.

Thus, when the UE releases the UL resources as indicated in the DCI message, the UE shall not provide acknowledgement for released UL resources as there will be no UL data transmission on the released resources.

However, if the resources are released, and further if the UE is allocated with another overlapping resource by the base station (which was overlapping with resources before releasing e.g., with occasion i+2 in step A in FIG. 4), then the UE shall send the acknowledgement on that overlapping resource, when the acknowledgment is enabled by the base station for the UE. In such case, after releasing the SPS resource(s), the UE transmits ACK, message or a NACK, message, related to the release of the SPS resource(s) from each of the UE(s). The UE may transmit the ACK message through one of hybrid automatic repeat request, HARQ, ACK, HARQ-ACK, codebook Type-1, HARQ-ACK, codebook Type-2, and enhanced HARQ-ACK, codebook Type-2 over a physical uplink control channel, PUCCH or a physical uplink shared channel, PUSCH.

The HARQ-ACK which is an Uplink Control Information, UCI, may be transmitted over PUCCH or multiplexed with PUSCH with some data, if PUSCH and PUCCH overlaps for the UE.

Further, the UE may transmit the HARQ-ACK through medium access control, MAC, control elements, MAC CEs over PUSCH. The MAC CEs may include a bit field indicating a partial release of the SPS resource(s) or a complete release of the SPS resource(s) indicated in the message.

If the UE transmits a NACK to the base station, then optionally, the UE may receive the DCI message comprising the information indicating the SPS resource(s) to be released by the UE.

Optionally, at step 508, the method 500 comprises receiving new information, for example, a new DCI message or a MAC CE comprising SPS resources reassigned by the base station after releasing the SPS resource(s). The UE may receive the new DCI message comprising the reassigned SPS resource(s) based on a change in traffic pattern for the UEs, change in channel conditions and emergence of high priority traffic or the like.

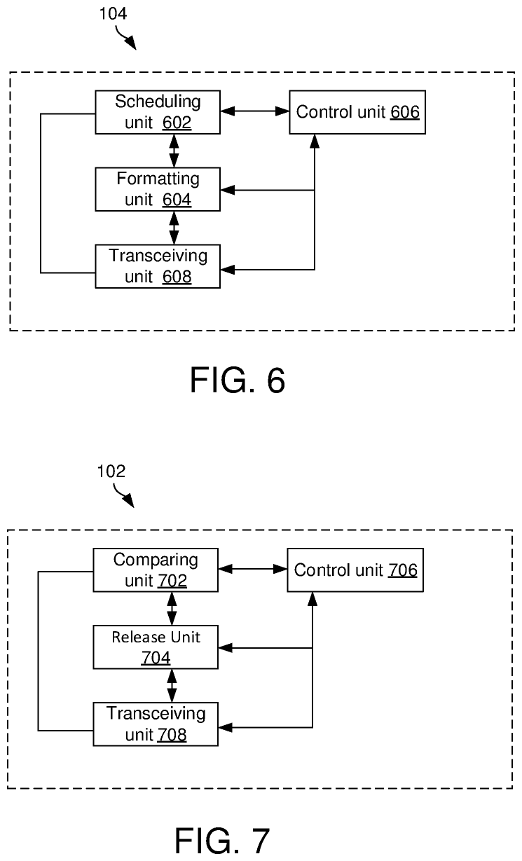

FIG. 6 is an example schematic diagram showing functional modules of a network node for handling release of SPS resource(s) configured for the UE(s). The network node in the form of a base station of a wireless communication network is capable of handling release of SPS resource(s), may comprise means arranged to perform the method for handling the release of SPS resource(s).

According to at least some embodiments of the present disclosure, the base station 104 as illustrated in FIG. 6 may comprise a scheduling unit 602, a formatting unit 604, and a transceiving unit 608. In addition, the base station 104 can also comprise a control unit 606, adapted to control said units.

The scheduling unit 602 may be adapted to determine the SPS resources which may be a UL SPS grant or DL assignment comprising the first set of physical layer parameters is to be released.

The formatting unit 604 may be adapted to generate the information or a DCI format indicating release of the SPS resource(s), corresponding to the step 304 as illustrated in FIG. 3.

Further, the transceiving unit 608 may be adapted to transmit the information (i.e., the DCI message or a MAC CE) to the UEs for causing the UEs to release the SPS resource(s), corresponding to step 306 as presented in FIG. 3. The scheduling unit 602, the formatting unit 604, and the transceiving unit 608 can be operatively connected to each other enabling the function of each of the units.

The scheduling unit 602 and the formatting unit 604 may be comprised in one processing unit, which additionally also may comprise the control unit 606. The function of the scheduling unit 602 may in this case be performed by scheduling means of a data processing unit. The function of the formatting unit 604 may be performed by formatting means for generating the DCI format according to embodiments of the present invention.

It should be noted that the release of SPS resources which are either of a SPS UL CG or DL assignment is equally applicable both in the downlink as well as the uplink of the wireless communication network. In the case of a UL SPS grant, this scheduling can be released by a UL dynamic scheduling grant, whereas in the case of a DL SPS assignment, this scheduling may be released by a DL dynamic scheduling assignment.

FIG. 7 is an example schematic diagram showing functional modules of a UE for releasing SPS resource(s). The UE of the wireless communication network is capable of releasing SPS resources, may comprise means arranged to perform the method for releasing SPS resources.

According to at least some embodiments of the present invention, the UE 102 in FIG. 7 comprises a comparing unit 702, a release unit 704, and a transceiving unit 708. In addition, the UE 102 can also comprise a control unit 706, adapted to control said units.

It can be mentioned that the comparing unit 702 and the release unit 704 may be merged into one and the same unit, which may be called a data processing unit, potentially also covering the control unit 706.

The comparing unit 702, the release unit 704, and the transceiving unit 708 as well as the control unit 706, may be operatively connected to each other.

The function of the comparing unit 702, when encompassed by the processing unit, may be performed by determining or comparing means of the processing unit. Likewise, the function of the release unit 704 may, when comprised by the processing unit, be performed by release means of the processing unit.

Optionally, the comparing unit 702 may be adapted to compare the SPS resource(s) received in the information to the SPS resource(s) configured for the UE 104. The release unit 704 may be adapted to release the SPS resource(s) under the condition that the received information fulfils the configured SPS resources at the comparison.

As described above, the fulfilment may be designed in various ways, a few of which have been mentioned above in connection to the explanation of FIG. 4.

The transceiving unit 706 can be adapted to receive the information, for example, the DCI message from the base station. Also, the transceiving unit 706 may have received the SPS resources i.e., SPS grant or assignment. The UE 102 may further comprise a control unit 708 adapted to control the steps as executed by the UE 104.

In addition, the transceiving unit 706 is also adapted to transmit the UL scheduling resource request, under the control of the control unit 708, to the base station, once the UE requires a radio resource allocation to transmit data to the base station.

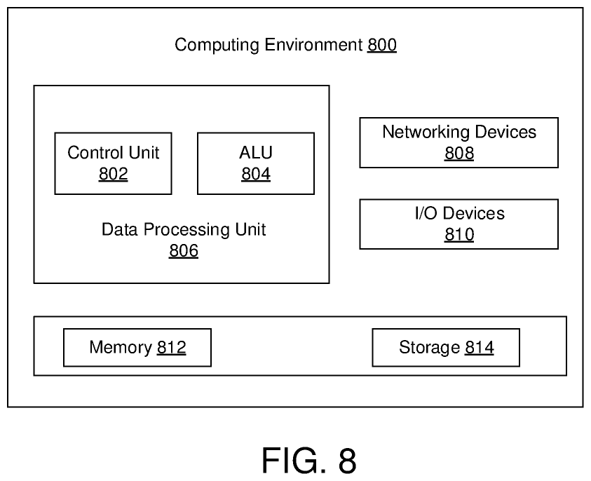

FIG. 8 illustrates an example computing environment 800 implementing a method and the network node and the UE for release of SPS resource(s) described in FIG. 3 and FIG. 5.

As depicted in FIG. 8, the computing environment 800 comprises at least one data processing unit 806 that is equipped with a control unit 802 and an Arithmetic Logic Unit, ALU 804, a memory 812, a storage 814, plurality of networking devices 808 and a plurality Input output, I/O devices 810. The data processing unit 806 is responsible for processing the instructions of the algorithm. For example, the data processing unit 806 is equivalent to the processing circuitry of the network node. The data processing unit 806 is capable of executing software instructions stored in memory 812. The data processing unit 806 receives commands from the control unit 802 in order to perform its processing. Further, any logical and arithmetic operations involved in the execution of the instructions are computed with the help of the ALU 804.

The computer program is loadable into the data processing unit 806, which may, for example, be comprised in an electronic apparatus (such as a UE or a network node). When loaded into the data processing unit 806, the computer program may be stored in the memory 812 associated with or comprised in the data processor. According to some embodiments, the computer program may, when loaded into and run by the data processing unit 806, cause execution of method steps according to, for example, any of the methods illustrated in FIGS. 3 and 5 or otherwise described herein

The overall computing environment 800 can be composed of multiple homogeneous and/or heterogeneous cores, multiple CPUs of different kinds, special media and other accelerators. The data processing unit 806 is responsible for processing the instructions of the algorithm. Further, the plurality of data processing units 806 may be located on a single chip or over multiple chips.

The algorithm comprising of instructions and codes required for the implementation are stored in either the memory 812 or the storage 814 or both. At the time of execution, the instructions may be fetched from the corresponding memory 812 and/or storage 814, and executed by the data processing unit 806.

In case of any hardware implementations various networking devices 808 or external I/O devices 810 may be connected to the computing environment to support the implementation through the networking devices 808 and the I/O devices 810.

The embodiments disclosed herein can be implemented through at least one software program running on at least one hardware device and performing network management functions to control the elements. The elements shown in FIG. 8 include blocks which can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

1. A method for handling release of semi-persistent scheduling (SPS) resources configured for one or more user equipments (UEs) in a wireless communication network, the method being performed by a network node, wherein the method comprises:
generating information indicating the release of one or more SPS resources, wherein the one or more SPS resources are a subset of SPS resources associated with a single SPS identifier (ID) or multiple SPS IDs configured for the one or more UEs; and
transmitting the generated information to the one or more UEs for causing the one or more UEs to release the one or more SPS resources.

2. The method according to claim 1, further comprising:
determining that the one or more SPS resources within a set of SPS resources configured for the one or more UEs is to be released.

3. The method according to claim 2, wherein determining that the one or more SPS resources within the set of SPS resources configured for the one or more UEs is to be released comprises:
determining whether the one or more UEs is configured with a single SPS ID, or multiple SPS IDs;
if the one or more UEs is configured with the single SPS ID, determining one or more SPS resources associated with the single SPS identifier (ID); and
if the one or more UEs is configured with multiple SPS IDs, determining one or more SPS resources associated with the multiple SPS IDs.

4. The method according to claim 1, wherein the generated information indicating the release of the one or more SPS resources comprises one or more of: a SPS ID, multiple SPS IDs, a start time interval to an end time interval associated with the one or more SPS resources, indication of SPS resources including a slot number, a start slot number to an end slot number associated with the one or more SPS resources, a physical resource block number (PRB), a start of PRB to an end of PRB, SPS periodicity, number of repetitions associated with SPS periodicity, number of repetitions in each of the SPS resources, periodic SPS resources in each slot, repetition IDs, a bitmap indicating one or more resource numbers, and a priority indicator indicating release of one or more SPS resources for a pre-determined time interval.

5. The method according to claim 4, wherein the number of repetitions of the periodic SPS resources defining a period over which the SPS resources reoccur, wherein the number of repetitions for each period are associated with one or more of a start time interval and an end time interval, a start slot number and an end slot number, a start of a periodic resource to an end of a periodic resource, wherein the number of the repetitions are associated with the single SPS ID or multiple SPS IDs.

6. The method according to claim 1, wherein the generated information is transmitted to the one or more UEs in one or more of: a Downlink Control Information (DCI), DCI, message and a Medium Access Control (MAC), Control Element (MAC-CE).

7. The method according to claim 1, wherein the generated information is transmitted to each UE based on a UE capability information received from each UE, for causing each UE to release the one or more SPS resources, and wherein the UE capability information being indicative of one or more of: releasing capability for release of the one or more SPS resources, processing capability for processing the received information, memory capacity for storing the received information.

8. The method according to claim 1, wherein the generated information is transmitted to a plurality of UEs in a group for causing the plurality of UEs to release the one or more SPS resources, wherein the plurality of UEs in a group is identified using a group ID.

9. The method according to claim 1, wherein a DCI message is transmitted to each UE to release the one or more SPS resources or a group-common DCI message is transmitted to the plurality of UEs to release the one or more SPS resources.

10. The method according to claim 1, wherein the one or more SPS resources within the set of SPS resources represent downlink (DL), SPS resources or uplink (UL), SPS resources configured for the one or more UEs.

11. The method according to claim 1, wherein the one or more SPS resources represent time-frequency resources supporting one or more resource configurations, and wherein the one or more resource configurations is one of a slot-based, a sub-slot based, a mini-slot based or a time symbol based resource configuration.

12. The method according to claim 1, wherein the method further comprises:
receiving an acknowledgement (ACK), message or a negative acknowledgement (NACK), message, related to the release of the one or more SPS resources from each of the one or more UEs; and
if the NACK is received from each of the one or more UEs, retransmitting the DCI message for causing the one or more UEs to release the one or more SPS resources.

13. The method according to claim 12, wherein the ACK message is received through one of hybrid automatic repeat request (HARQ), ACK, HARQ-ACK, codebook Type-1, HARQ-ACK, codebook Type-2, enhanced HARQ-ACK, codebook Type-2 and HARQ-ACK, codebook Type-3 over a physical uplink control channel (PUCCH) or a physical uplink shared channel (PUSCH).

14. The method according to claim 1, wherein the ACK message is received through medium access control (MAC) control elements, MAC CEs over PUSCH, wherein the MAC CEs comprises a bit field indicating a release of the one or more SPS resources or a complete release of the SPS resources.

15. The method according to claim 1, wherein the method further comprises:
transmitting new information to the one or more UEs for re-assigning the one or more SPS resources released by the one or more UEs.

16. A method for releasing semi-persistent scheduling (SPS), resources configured for a user equipment (UE) in a wireless communication network, the method being performed by the UE, wherein the method comprises:
receiving, from a network node, information indicating release of one or more SPS resources within a set of SPS resources configured for the UE, wherein the one or more SPS resources are a subset of SPS resources associated with a single SPS identifier, ID, or multiple SPS IDs; and
releasing the one or more SPS resources indicated in the received information.

17. The method according to claim 16, wherein the information indicating the release of the one or more SPS resources comprises one or more of: a SPS ID, multiple SPS IDs, a start time interval to an end time interval associated with the one or more SPS resources, a slot number, a start slot number to an end slot number associated with the one or more SPS resources, a physical resource block number (PRB), a start of PRB to an end of PRB, SPS periodicity, number of repetitions associated with SPS periodicity, number of repetitions in each of the SPS resources, periodic SPS resources in each slot, repetition IDs, a bitmap indicating one or more resource numbers, a bitmap indicating one or more resource numbers, and a priority indicator indicating release of one or more SPS resources for a pre-determined time interval.

18. The method according to claim 17, wherein the number of repetitions of the periodic SPS resources defining a period over which the SPS resources reoccur, wherein the number of repetitions for each period are associated with one or more of a start time interval and an end time interval, a start slot number and an end slot number, a start of a periodic resource to an end of a periodic resource, wherein the number of the repetitions are associated with the single SPS ID or multiple SPS IDs.

19. The method according to claim 16, wherein the information indicating the release of the one or more SPS resources is received in one or more of: a Downlink Control Information (DCI), message and a Medium Access Control (MAC), Control Element (MAC-CE).

20. The method according to claim 16, wherein the one or more SPS resources within the set of SPS resources represent downlink (DL) SPS resources or Uplink (UL) SPS resources, wherein the UE releases the one or more SPS resources associated with pre-determined beams or antenna ports.

21-51. (canceled)
